(19) United States
(12) Patent Application Publication
(10) Pub. No.: US 2026/0012076 A1
(43) Pub. Date: Jan. 8, 2026

(54) INVERTER CONTROL DEVICE USING DUAL CORE AND DATA PROCESSING METHOD OF ONE CORE

(71) Applicant: HYUNDAI AUTOEVER CORP., Seoul (KR)

(72) Inventors: Dong Hui Lim, Seoul (KR); Eun Su Jun, Seoul (KR)

(73) Assignee: HYUNDAI AUTOEVER CORP., Seoul (KR)

(21) Appl. No.: 19/258,455

(22) Filed: Jul. 2, 2025

(30) Foreign Application Priority Data
Jul. 5, 2024 (KR) 10-2024-0088731

(51) Int. Cl. H02M 1/00

(52) U.S. Cl. CPC H02M 1/0012; H02M 1/0009; H02M 1/0025

(57) ABSTRACT

An inverter control device includes a first core configured to execute control calculation logic to calculate a switching pulse-width modulation (PWM) control value by using an analog-to-digital converter (ADC) sampling value for an inverter. The inverter control device further includes a second core configured to execute update logic to store the switching PWM control value in a buffer-data variable; store a value of the buffer-data variable in a previous-data variable; and update a register with the value of the buffer-data variable or the previous-data variable according to an execution state of the control calculation logic. The inverter control device further includes a PWM control circuit configured to output a switching PWM signal to control the inverter, by using a value within the register.

### CROSS-REFERENCE TO RELATED APPLICATION

This application claims the benefit of and priority to Korea Patent Application No. 10-2024-0088731, filed on Jul. 5, 2024, the entire contents of which are hereby incorporated herein by reference.

### FIELD OF TECHNOLOGY

The present disclosure relates to an inverter. Particularly, the present disclosure relates to inverter control device using dual core and a data processing method of one core.

### BACKGROUND

Inverters are devices that convert electric power. The primary function of these devices is to convert direct current (DC) power to alternating current (AC) power. Inverters play an essential role in applications, such as photovoltaic power generation, electric vehicle charging infrastructure, uninterruptible power supplies (UPSs), and general household electrical equipment. DC power is typically generated in photovoltaic panels or storage devices such as batteries. This generated DC power is converted via an inverter into AC power suitable for use in homes or businesses. Voltage regulation also occurs during this process, and low-voltage DC is stepped up to high-voltage AC to supply power according to user requirements. Inverter technology is crucial for improving energy efficiency, minimizing power loss, and enabling a stable power supply.

Inverters convert DC voltage to AC voltage via pulse-width modulation (PWM) control. An inverter typically includes six power semiconductor switches, which are commonly insulated-gate bipolar transistors (IGBTs) or metal-oxide-semiconductor field-effect transistors (MOSFETs). These semiconductors are precisely controlled to receive a voltage and convert the received voltage into an AC voltage.

A PWM control method involves generating an AC voltage with a desired voltage and frequency by adjusting the operating time of each switch. Here, the switches adjust the width of a signal (where a wider signal corresponds to a higher voltage and a narrower signal corresponds to a lower voltage) by turning on and off at significantly high speeds. This process is used to synthesize a desired waveform, such as a sine wave, ultimately enabling an efficient and precise power supply.

The inverter senses an output current, an output voltage, and an input voltage via an analog-to-digital converter (ADC) and then uses this data to calculate a PWM duty cycle for the next switching period. Sensors connected to the inverter sense changes in current and voltage as analog signals, which are then converted into digital data via the ADC. Through this conversion, an inverter control device obtains real-time data enabling precise power regulation.

The digitally converted voltage-current data is processed by the inverter control device. During this processing, an optimal PWM duty cycle is calculated based on input power conditions. The PWM duty cycle determines the duration for which the power semiconductor switches within the inverter remain turned on, and this is used to adjust the waveform, frequency, and phase of the converted AC voltage.

The inverter may perform ADC sensing once per switching period, subsequently may execute calculations for controlling the next switching period, and then may set the calculation result in a register. When more precise control is required, the inverter may perform ADC sensing twice per switching period. This is also referred to as double sampling.

However, applying such double sampling to an inverter reduces the margin of a control load factor, and when a control interrupt service routine (ISR) is delayed, situations may arise where ensuring data coherency becomes difficult.

The discussions in this section are intended merely to provide background information and do not constitute an admission of prior art.

### SUMMARY

An objective of the present disclosure is to provide an inverter control technology capable of ensuring data coherency in any case. Another objective of the present disclosure is to provide a data processing technology capable of ensuring data coherency in an inverter performing double sampling.

To achieve the above-mentioned objectives, an inverter control device according to an embodiment of the present disclosure includes a first core configured to execute control calculation logic to calculate a switching pulse-width modulation (PWM) control value by using an analog-to-digital converter (ADC) sampling value for an inverter. The inverter control device further includes a second core configured to execute update logic to store the switching PWM control value in a buffer-data variable; store a value of the buffer-data variable in a previous-data variable; and update a register with the value of the buffer-data variable or the previous-data variable according to an execution state of the control calculation logic. The inverter control device further includes a PWM control circuit configured to output a switching PWM signal to control the inverter, by using a value within the register.

The second core may be further configured to divide each switching PWM period into a first control period and a second control period and execute the update logic in each of the first control period and the second control period.

When the first core executes the control calculation logic once in each switching PWM period, the second core is configured to execute the update logic to update, in the first control period, the register with the value of the previous-data variable; and update, in the second control period, the register with the value of the buffer-data variable.

The first core is configured to execute the control calculation logic to change a status variable to a first status value; store the switching PWM control value in a new-data variable; and after the storing in the new-data variable is completed, change the status variable to a second status value. When the status variable is the first status value, the second core is configured to execute the update logic to update the register with the value of the previous-data variable.

The second core is configured to execute the update logic to, after updating the register, wait until the status variable is changed to the second status value; and store a value of the new-data variable in the buffer-data variable.

The first core is configured to execute the control calculation logic to change a status variable to a first status value; store the switching PWM control value in a new-data variable; and after the storing in the new-data variable is completed, change the status variable to a second status value. When the status variable is the second status value, the second core is configured to execute the update logic to store a value of the new-data variable in the buffer-data variable and update the register with the value of the buffer-data variable.

When a structure variable includes a status variable and a count variable, the first core is configured to execute the control calculation logic to increment a value of the count variable; change the status variable to a first status value; store the switching PWM control value in a new-data variable; and after the storing in the new-data variable is completed, change the status variable to a second status value and increment a value of the count variable When the structure variable comprises the status variable and the count variable, the second core is configured to execute the update logic to store the structure variable in a temporary variable; and when a status variable of the temporary variable is the second status value and a value of a count variable of the temporary variable is different from the value of the count variable of the structure variable, re-store the structure variable in the temporary variable and determine the execution state of the control calculation logic.

When the status variable of the re-stored temporary variable is the first status value, the second core is configured to execute the update logic to update the register with the value of the previous-data variable.

The second core is configured to execute the update logic may, after updating the register, wait until the status variable of the temporary variable is changed to the second status value while continuously storing the structure variable in the temporary variable; and store the value of the new-data variable in the buffer-data variable.

When the status variable of the re-stored temporary variable is the second status value, the second core is configured to execute the update logic to store the value of the new-data variable in the buffer-data variable; and update the register with the value of the buffer-data variable.

The second core may be further configured to divide each switching PWM period into a first control period and a second control period; and execute the update logic in a predetermined time interval within each of the first control period and the second control period.

A data processing method of a core according to an embodiment of the present disclosure includes dividing each switching pulse-width modulation (PWM) period into a first control period and a second control period. The method further includes determining whether a current control period is the first control period or the second control period. The method further includes, in the first control period, determining a number of ADC samplings of another core in each switching PWM period. The method further includes determining when the number of ADC samplings is 1, executing first update logic to update a register with a value of a previous-data variable. The method further includes determining when the number of ADC samplings is 2 or greater, executing second update logic to update the register with a value of a buffer-data variable or the value of the previous-data variable according to an execution state of control calculation logic executed by the another core. The method further includes executing the second update logic in the second control period.

When a structure variable includes a status variable and a count variable, the method further includes executing a first storage logic to store, in the buffer-data variable, a value of a new-data variable.

Executing the second update logic may include: executing a second storage logic; storing a value of the structure variable in a temporary variable; determining whether a status variable of the temporary variable is a first status value; and when the status variable of the temporary variable is the first status value, updating the register with the value of the previous-data variable.

Executing the second update logic may further include, after the updating of the register with the value of the previous-data variable, waiting until the status variable of the temporary variable is changed to the second status value while continuously storing the structure variable in the temporary variable; and after the updating of the register with the value of the previous-data variable, executing the first storage logic to store, in the buffer-data variable, the value of the new-data variable.

Executing the second update logic may further include, when the status variable of the temporary variable is the second status value: executing the first storage logic to store, in the buffer-data variable, the value of the new-data variable and update the register with the value of the buffer-data variable; comparing a value of a count variable of the temporary variable with a value of the count variable of the structure variable; and when the value of the count variable of the temporary variable is equal to the value of the count variable of the structure variable, updating the register with the value of the buffer-data variable and executing the second storage logic to store, in the previous-data variable, the value of the buffer-data variable.

Executing the second update logic may further include, when the value of the count variable of the temporary variable is different from the value of the count variable of the structure variable: re-storing the structure variable in the temporary variable; determining whether the status variable of the re-stored temporary variable is the first status value; and when the status variable of the re-stored temporary variable is the first status value, updating the register with the value of the previous-data variable.

The first update logic or the second update logic may be executed in a predetermined time interval within the first control period.

An inverter control device according to an embodiment includes a first core configured to divide each switching pulse-width modulation (PWM) period into a first control period and a second control period; and in each control period, execute calculation logic to calculate a switching PWM control value by using an ADC sampling value for an inverter and execute data sharing logic to store, in a new-data variable within a shared memory, the switching PWM control value. The inverter control device further includes a second core configured to execute update logic to update a register in a predetermined update interval within each control period; when an update time point of the new-data variable is earlier than a set time point within the update interval, execute the update logic to update the register with a value of a buffer-data variable storing a value of the new-data variable; and when the update time point of the new-data variable is later than the set time point, execute the update logic to update the register with a value of a previous-data variable storing a previous value of the buffer-data variable. The inverter control device further includes a PWM control circuit configured to output a switching PWM signal to control the inverter, by using a value within the register.

The second core may be further configured to, after updating the register with the value of the previous-data variable, store, in the buffer-data variable, the value of the new-data variable.

As described above, according to an embodiment of the present disclosure, an inverter may maintain data coherency in any case. Furthermore, according to an embodiment of the present disclosure, data coherency may be ensured in an inverter in which double sampling is performed.

### BRIEF DESCRIPTION OF THE DRAWINGS

In order for one having ordinary skill in the art to understand the present disclosure, various forms of the present disclosure are described given by way of example with reference to the accompanying drawings, in which:

FIG. 1 is a diagram illustrating a general inverter performing single-sampling control by using a single core;

FIG. 2 is a diagram illustrating a general inverter performing double-sampling control by using a single core;

FIG. 3 is a diagram illustrating a problem that may arise when a general inverter performs double-sampling control by using a single core;

FIG. 4 is a diagram illustrating an example of performing single-sampling control in an inverter, according to an embodiment;

FIG. 5 is a diagram illustrating a first example of performing double-sampling control in an inverter, according to an embodiment;

FIG. 6 is a diagram illustrating a second example of performing double-sampling control in an inverter, according to an embodiment;

FIG. 7 is a diagram illustrating a third example of performing double-sampling control in an inverter, according to an embodiment;

FIG. 8 is a diagram illustrating a fourth example of performing double-sampling control in an inverter, according to an embodiment;

FIG. 9 is a configuration diagram of an inverter control device according to an embodiment;

FIG. 10 is a flowchart of a data sharing logic according to an embodiment;

FIG. 11 is a flowchart of update logic for a first case, according to an embodiment;

FIG. 12 is a flowchart of update logic for a second case, according to an embodiment;

FIG. 13 is a flowchart of update logic for a third case, according to an embodiment;

FIG. 14 is a flowchart of update logic for a fourth case, according to an embodiment;

FIG. 15 is a flowchart of update logic for a fifth case, according to an embodiment; and

FIG. 16 is a flowchart of a data processing method of a second core according to an embodiment.

### DETAILED DESCRIPTION

Hereinafter, some embodiments of the present disclosure are described in detail with reference to diagrams. It should be noted that in assigning reference numerals to components in each drawing, identical or equivalent components are intended to have the same reference numerals whenever possible, even if they are illustrated in different drawings. Furthermore, in the description of the present disclosure, if a detailed description of related known configurations or functions is determined to potentially obscure the gist of the present disclosure, such a detailed description has been omitted.

In addition, in describing components of the present disclosure, expressions such as “first”, “second”, “A”, “B”, “(a)”, or “(b)” may be used. These expressions are only intended to distinguish one component from another and do not limit the nature, order, or sequence of the components. It should be understood that, when it is described that a first element is “connected,” “coupled,” or “joined” to a second element, the first element may be directly connected, coupled, or joined to the second element, or the first element may be connected, coupled, or joined to the second element with a third element connected, coupled, or joined therebetween. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

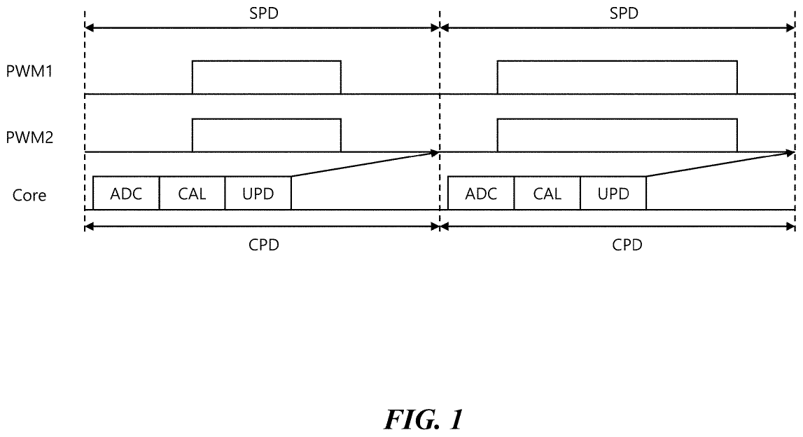

FIG. 1 is a diagram illustrating a general inverter performing single-sampling control by using a single core.

Referring to FIG. 1, the inverter may perform analog-to-digital converter (ADC) sensing once within each switching period SPD (ADC).

The inverter may then calculate control parameters based on obtained ADC sensing data (CAL). For example, the inverter may calculate a rising edge value and/or a falling edge value for determining a pulse-width modulation (PWM) duty cycle. Alternatively, the inverter may calculate a PWM duty cycle value and may also calculate other modified values.

The inverter may update a storage with the calculated control value (UPD). Here, the storage may be a register. The inverter may store the rising edge value in a control mode (CM) register or in another register. Such calculation of the control value and updating of the register may be performed by a core.

In addition, a driver for generating a PWM signal may generate a PWM signal by comparing a value stored in the register with a comparison value (e.g., a counter value) (PWM1 and PWM2).

When a period during which the inverter performs PWM control is referred to as the switching period (SPD), and an interval during which the control value is updated is referred to as a control period (CPD), in a general inverter performing single-sampling control, the switching period SPD and the control period CPD may have the same duration.

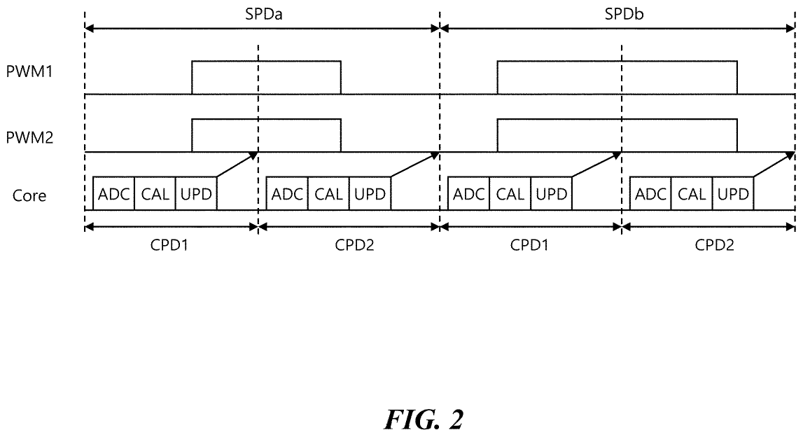

FIG. 2 is a diagram illustrating a general inverter performing double-sampling control by using a single core.

Referring to FIG. 2, the inverter may divide each switching period SPDa or SPDb into two control periods CPD1 and CPD2, may perform ADC sensing in each of the control periods CPD1 and CPD2 (ADC), may calculate a control value based on ADC sensing data (CAL), may and update a storage with the control value (UPD).

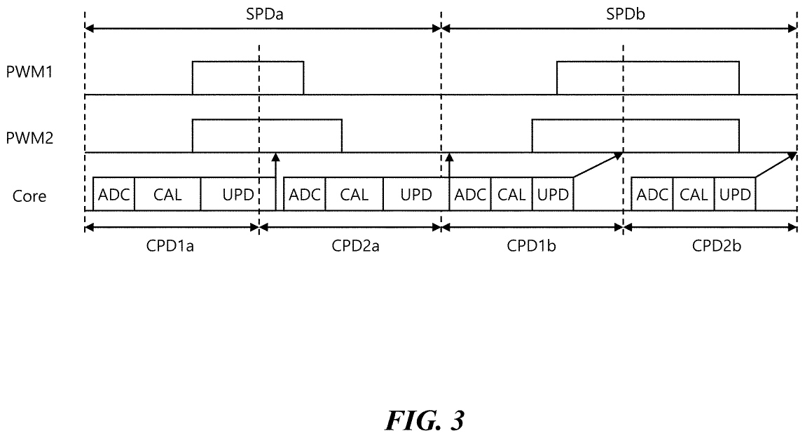

FIG. 3 is a diagram illustrating a problem that may arise when a general inverter performs double-sampling control by using a single core.

Referring to FIG. 3, when the time required for the core of the inverter to calculate the control value based on the ADC sensing data (CAL), or the time required to update the storage with the control value (UPD), is prolonged, the time point of updating the storage with the control value may exceed the end time point of one control period. For example, referring to FIG. 3, it may be observed that updates are not completed within a first control period CPD1a and a second control period CPD2a of the first switching period SPDa.

In such a case, the calculated control value may be applied not in the intended control period but in a subsequent control period, which may compromise data coherency.

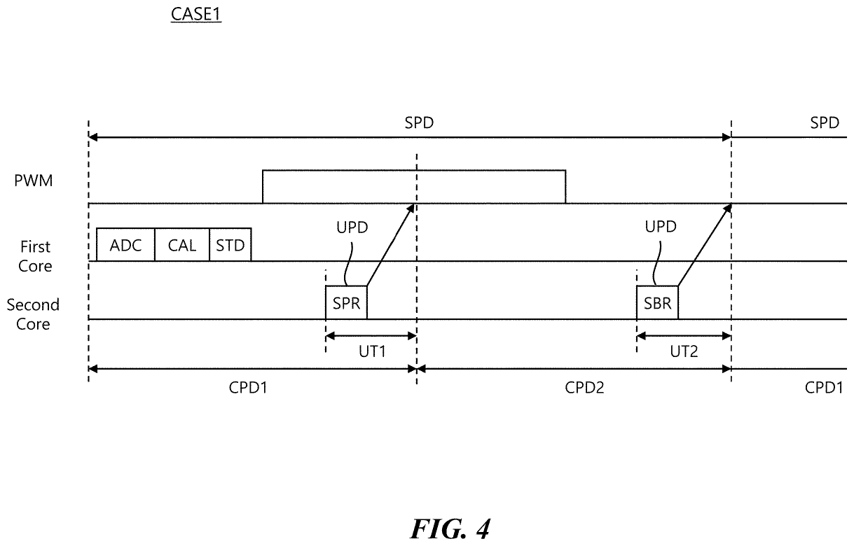

FIG. 4 is a diagram illustrating an example of performing single-sampling control in an inverter, according to an embodiment.

For convenience of description, an example described with reference to FIG. 4 is referred to as a first case CASE1.

Referring to FIG. 4, the inverter may perform data processing in a distributed manner between a first core (Core X) and a second core (Core Y).

In a first control period CPD1, the first core may perform analog-to-digital conversion ADC, calculation logic CAL (CALculation), and data sharing logic SeT Data (STD). The calculation logic and the data sharing logic may be collectively referred to as control calculation logic.

Hereinafter, for convenience of description, the reference numeral for each logic is also used in the drawings to indicate a time interval during which that logic is performed. For example, in FIG. 4, CAL may indicate a time interval during which the calculation logic is performed, and STD may indicate a time interval during which the data sharing logic is performed. In addition, ADC may indicate a time interval during which analog-to-digital conversion is performed.

The calculation logic CAL may enable the first core to calculate a switching PWM control value by using an ADC sampling value for the inverter.

Here, the switching PWM control value may be, for example, a duty cycle value of switching PWM and may be a rising edge value and/or a falling edge value of switching PWM.

In addition, the data sharing logic STD may be logic that enables the first core to store the calculated switching PWM control value in a variable within a shared memory. Here, the variable stored in the shared memory may be referred to as a new-data variable.

One switching period SPD may be divided into two control periods CPD1 and CPD2.

In the first control period CPD1, the second core may store, in a buffer-data variable, the value stored in the new-data variable within the shared memory.

Logic that enables the second core to update a register with the value of a previous-data variable or the buffer-data variable in an update interval UT1 or UT2 may be referred to as UPdate Data (UPD), and within the update logic UPD, the partial logic that updates the register with the value of the previous-data variable may be referred to as Set Predata to Register (SPR), and the partial logic that updates the register with the value of the buffer-data variable may be referred to as Set Bufdata to Register (SBR).

In the first update interval UT1 that is set within the first control period CPD1, the second core may update a storage (e.g., a register, hereinafter, for convenience of description, ‘storage’ is referred to as ‘register’) with the value of the previous-data variable (SPR). Here, the previous-data variable is a variable that stores the previous value of the buffer-data variable, and the second core may store, in the previous-data variable, the value of the buffer-data variable.

The second core may update the register with the value of the buffer-data variable or the previous-data variable according to the execution state of the control calculation logic (CAL and STD). In the first case CASE1, the second core may update the register with the value of the previous-data variable (SPR) in the first control period CPD1 and may update the register with the value of the buffer-data variable (SBR) in the second control period CPD2.

In addition, a PWM control circuit may output a switching PWM signal (‘PWM’ in FIG. 4) that controls the inverter, by using values in the register.

The first core, the second core, and the PWM control circuit may be collectively referred to as an inverter control device.

The second core may update the register in the predetermined update intervals UT1 and UT2, within the control periods CPD1 and CPD2, respectively. Accordingly, even when the calculation time of the core is prolonged, data coherency may be ensured.

Furthermore, by separating the buffer-data variable and the previous-data variable, the inverter control device according to an embodiment may be applied to both single sampling and double sampling.

In addition, by performing data processing in a distributed manner between the first core and the second core, problems in data processing caused by processing time delays in the first core may also be mitigated.

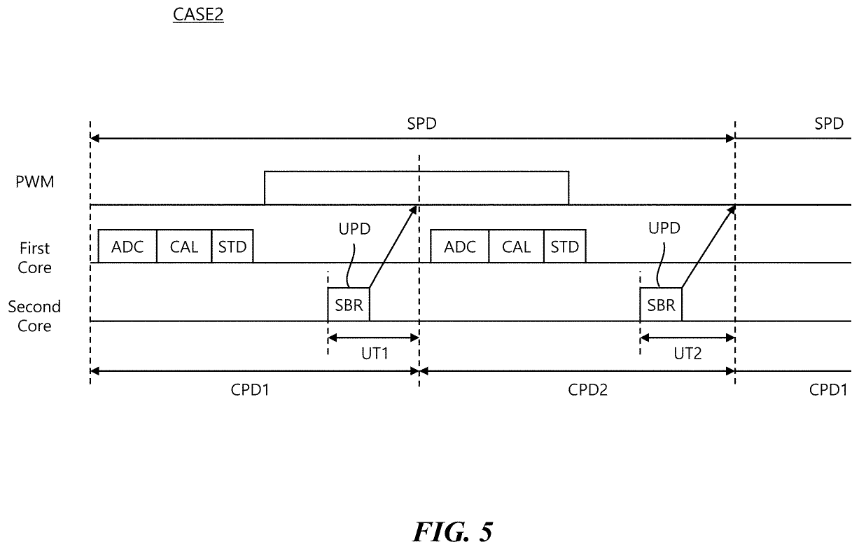

FIG. 5 is a diagram illustrating a first example of performing double-sampling control in an inverter, according to an embodiment.

For convenience of description, an example described with reference to FIG. 5 is referred to as a second case CASE2.

Referring to FIG. 5, the first core may calculate a switching PWM control value by using an ADC sampling value for the inverter (CAL). Then, the first core may store the calculated switching PWM control value in a new-data variable within a shared memory (STD).

One switching period SPD may be divided into two control periods CPD1 and CPD2. In addition, the core may repeatedly perform ADC, CAL, and STD in each of the control periods CPD1 and CPD2.

In addition, in the update intervals UT1 and UT2 of the respective control periods CPD1 and CPD2, the second core may store, in a buffer-data variable, the value stored in the new-data variable within the shared memory and may update a register with the value of the buffer-data variable (SBR).

For example, in the first update interval UT1 of the first control period CPD1, the second core may store, in the buffer-data variable, the value stored in the new-data variable within the shared memory and may update the register with the value of the buffer-data variable (SBR). In addition, in the second update interval UT2 of the second control period CPD2, the second core may store, in the buffer-data variable, the value stored in the new-data variable within the shared memory and may update the register with the value of the buffer-data variable (SBR).

The second core may update the register in the predetermined update intervals UT1 and UT2 within the respective control periods CPD1 and CPD2. Accordingly, even when the calculation time of the first core is prolonged, data coherency may be ensured.

Furthermore, by separating the buffer-data variable and the previous-data variable, the inverter control device according to an embodiment may be applied to both single sampling and double sampling.

In addition, by performing data processing in a distributed manner between the first core and the second core, problems in data processing caused by processing time delays in the first core may also be mitigated.

Meanwhile, due to a calculation time delay or a data storage delay in the first core, the operation of the second core may not be performed as in the second case CASE2. In such a case, the second core may update the register with the value of the previous-data variable and then may update the register with the value of the buffer-data variable in the subsequent control period.

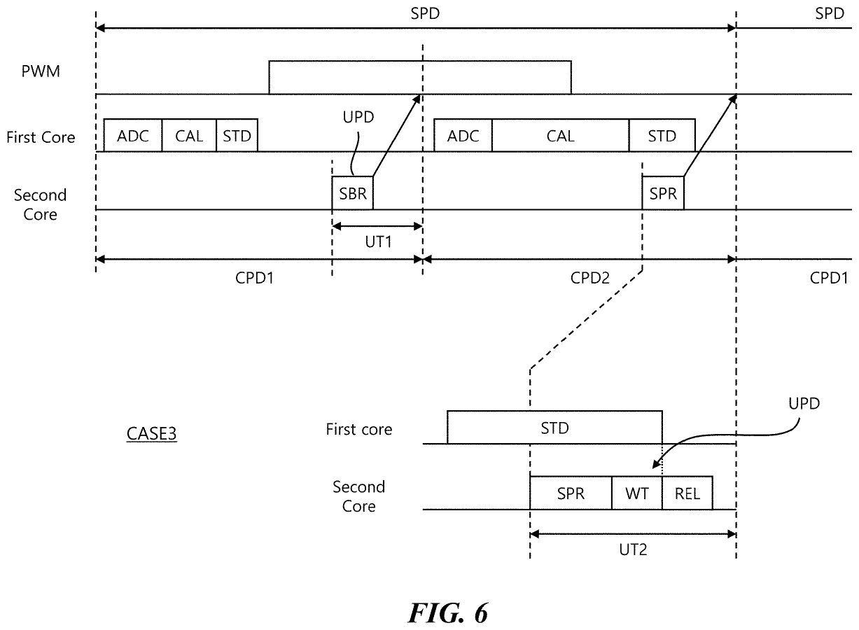

FIG. 6 is a diagram illustrating a second example of performing double-sampling control in an inverter, according to an embodiment.

For convenience of description, an example described with reference to FIG. 6 is referred to as a third case CASE3.

Referring to FIG. 6, the first core may repeatedly perform ADC, CAL, and STD in each of the control periods CPD1 and CPD2.

However, in a certain control period (the second control period in FIG. 6), an execution time period of the calculation logic CAL may be prolonged, and thus the time point at which the data sharing logic STD updates the new-data variable may be later than a set time point within the interval for the update logic UPD.

Referring to the enlarged view of the second update interval UT2 in FIG. 6, although the start time point of the data sharing logic STD is earlier than the start time point of the second update interval UT2, the end time point of the data sharing logic STD may be later than the end time point of the logic SPR that updates the register.

In the third case CASE3, the update logic UPD of the second core may first update the register with the value of the previous-data variable (SPR). In addition, the update logic UPD of the second core may wait for the new-data variable to be updated (Waiting Time (WT)), and after the new-data variable is updated, store, in the buffer-data variable, the value of the new-data variable (Reload (REL)).

The first core and the second core may share information about the update status of the new-data variable through a status variable. Here, the status variable may be located in the shared memory.

The data sharing logic STD of the first core may change the status variable to a first status value and then store the switching PWM control value in the new-data variable. In addition, after the storage into the new-data variable is completed, the data sharing logic STD may change the status variable to a second status value.

When the status variable is the first status value, the update logic UPD of the second core may update the register with the value of the previous-data variable. In addition, when the status variable is the second status value, the update logic UPD of the second core may update the register with the value of the buffer-data variable.

When a set time point for updating the register is reached, and the status variable is the first status value, the update logic UPD of the second core may update the register with the value of the previous-data variable (SPR). In addition, after updating the register, the update logic UPD may wait until the status variable is changed to the second status value (WT). Then, after the status variable is changed to the second status value, the update logic UPD may store, in the buffer-data variable, the value of the new-data variable (REL).

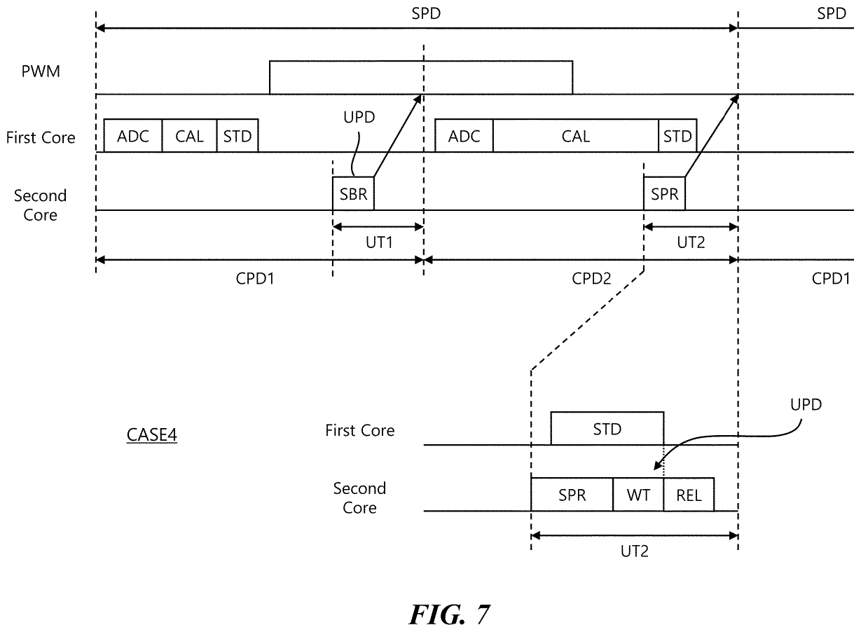

FIG. 7 is a diagram illustrating a third example of performing double-sampling control in an inverter, according to an embodiment.

For convenience of description, an example described with reference to FIG. 7 is referred to as a fourth case CASE4.

Referring to FIG. 7, the first core may repeatedly perform ADC, CAL, and STD in each of the control periods CPD1 and CPD2.

However, in a certain control period (the second control period in FIG. 7), an execution time period of the calculation logic CAL may be prolonged, and thus the time point at which the data sharing logic STD updates the new-data variable may be later than a set time point within the interval for the update logic UPD.

Referring to the enlarged view of the second update interval UT2 in FIG. 7, the start time point of the data sharing logic STD may be later than the start time point of the second update interval UT2. In addition, the end time point of the data sharing logic STD may be later than the end time point of the logic SPR that updates the register.

In the fourth case CASE4, the update logic UPD of the second core may first update the register with the value of the previous-data variable (SPR). In addition, the update logic UPD of the second core may wait for the new-data variable to be updated (WT), and after the new-data variable is updated, the update logic UPD of the second core may store, in the buffer-data variable, the value of the new-data variable (REL).

The first core and the second core may share information about the update status of the new-data variable through a status variable. Here, the status variable may be located in the shared memory.

The data sharing logic STD of the first core may change the status variable to a first status value and then store the switching PWM control value in the new-data variable. In addition, after the storage into the new-data variable is completed, the data sharing logic STD may change the status variable to a second status value.

When the status variable is the first status value, the update logic UPD of the second core may update the register with the value of the previous-data variable. In addition, when the status variable is the second status value, the update logic UPD of the second core may update the register with the value of the buffer-data variable.

However, when the update logic UPD inspects the status variable, and the data sharing logic STD has not yet started, the status variable may still be the second status value. Because the status variable may maintain the second status value in a state in which the new-data variable is not updated, the first core and the second core may increase the accuracy of sharing status information, through another variable.

The first core and the second core may share a structure variable, which includes a status variable and a count variable, through a shared memory or the like.

The data sharing logic STD of the first core may increase the value of the count variable included in the structure variable, may change the status variable to a first status value, and then may store the switching PWM control value in the new-data variable. In addition, after the storage into the new-data variable is completed, the data sharing logic STD may change the status variable to the second status value and may increment the value of the count variable.

When a set time point for updating the register is reached, the update logic UPD of the second core may store the structure variable in a temporary variable. Then, when the status variable of the temporary variable is the second status value, and the count variable value of the temporary variable is different from the count variable value of the structure variable, the update logic UPD may store the structure variable in the temporary variable again and then may repeatedly recheck the execution state of the data sharing logic STD.

In addition, when the status variable of the re-stored temporary variable is the first status value, the update logic UPD may update the register with the value of the previous-data variable (SPR). In addition, after updating the register, the update logic UPD may wait until the status variable of the temporary variable is changed to the second status value (WT), while continuously storing the structure variable in the temporary variable. Then, after the status variable is changed to the second status value, the update logic UPD may store the value of the new-data variable in the buffer-data variable (REL).

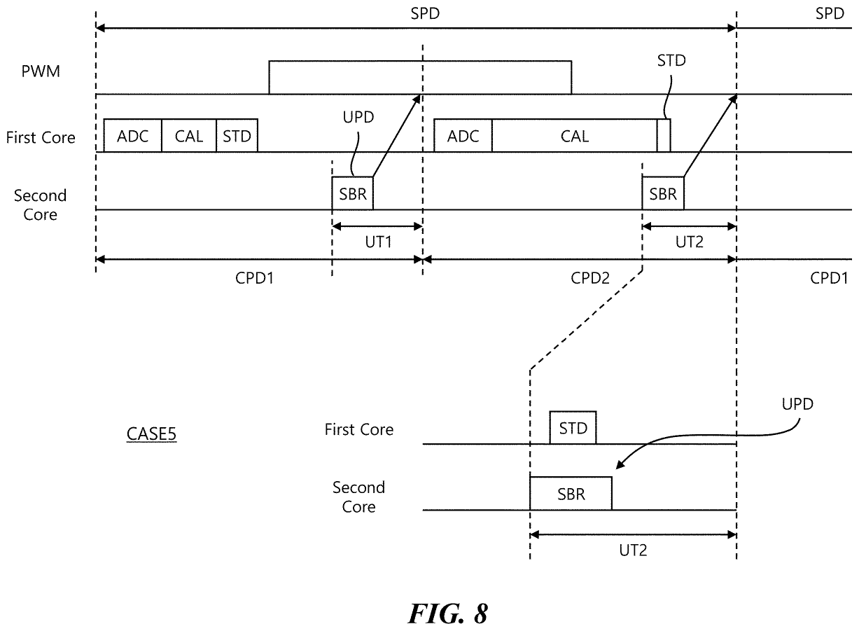

FIG. 8 is a diagram illustrating a fourth example of performing double-sampling control in an inverter, according to an embodiment.

For convenience of description, an example described with reference to FIG. 8 is referred to as a fifth case CASE5.

Referring to FIG. 8, the first core may repeatedly perform ADC, CAL, and STD in each of the control periods CPD1 and CPD2.

However, in a certain control period (e.g., the second control period in FIG. 8), the execution time period of the calculation logic CAL may be prolonged, and thus the start time point of the data sharing logic STD may be later than the start time point of the update logic UPD.

Referring to the enlarged view of the second update interval UT2 in FIG. 8, the start time point of the data sharing logic STD may be later than the start time point of the second update interval UT2.

The first core and the second core may share information about the update status of the new-data variable through a status variable. Here, the status variable may be located in the shared memory.

The data sharing logic STD of the first core may change the status variable to a first status value and then store the switching PWM control value in the new-data variable. In addition, after the storage into the new-data variable is completed, the data sharing logic STD may change the status variable to a second status value.

When the status variable is the first status value, the update logic UPD of the second core may update the register with the value of the previous-data variable. In addition, when the status variable is the second status value, the update logic UPD of the second core may update the register with the value of the buffer-data variable.

However, when the update logic UPD inspects the status variable, and the data sharing logic STD has not yet started, the status variable may still be the second status value. Because the status variable may maintain the second status value in a state in which the new-data variable is not updated, the first core and the second core may increase the accuracy of sharing status information, through another variable.

The first core and the second core may share a structure variable, which includes a status variable and a count variable, through a shared memory or the like.

The data sharing logic STD of the first core may increase the value of the count variable included in the structure variable, may change the status variable to a first status value, and then may store the switching PWM control value in the new-data variable. In addition, after the storage into the new-data variable is completed, the data sharing logic STD may change the status variable to the second status value and may increment the value of the count variable.

When a set time point for updating the register is reached, the update logic UPD of the second core may store the structure variable in a temporary variable. Then, when the status variable of the temporary variable is the second status value, and the count variable value of the temporary variable is different from the count variable value of the structure variable, the update logic UPD may store the structure variable in the temporary variable again and then repeatedly recheck the execution state of the data sharing logic STD.

In addition, when the status variable of the re-stored temporary variable is the second status value, the update logic UPD may store the value of the new-data variable in the buffer-data variable and may update the register with the value of the buffer-data variable (SBR).

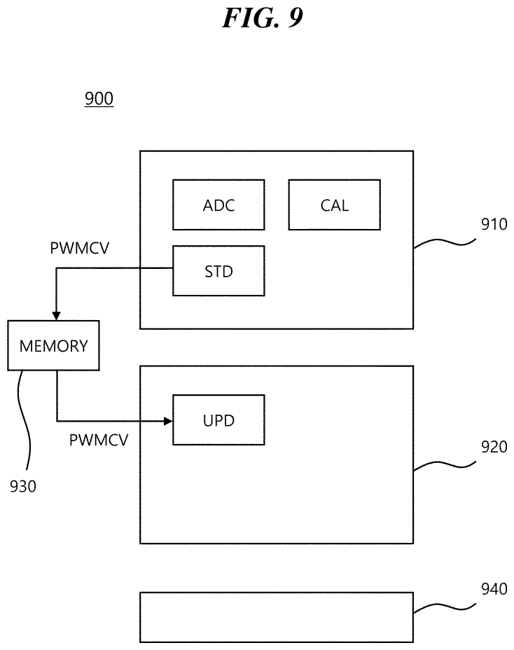

FIG. 9 is a configuration diagram of an inverter control device according to an embodiment.

Referring to FIG. 9, the inverter control device may include a first core 910, a second core 920, a shared memory 930, a PWM control circuit 940, and the like.

The first core 910 may include ADC sensing logic (ADC), calculation logic (CAL), and data sharing logic (STD).

The ADC sensing logic ADC may obtain an ADC sampling value by driving an ADC circuit. Alternatively, the ADC sensing logic ADC may obtain an ADC sampling value generated elsewhere, by using communication or the like.

The calculation logic CAL may calculate a switching PWM control value PWMCV by using an ADC sampling value.

Then, the data sharing logic STD may store the switching PWM control value PWMCV, which has been calculated by the calculation logic CAL, in the shared memory 930. For example, the data sharing logic STD may store the switching PWM control value PWMCV in a new-data variable within the shared memory 930. In addition, the data sharing logic STD may manage a status variable and a count variable to manage the update status of the new-data variable.

The new-data variable and a structure variable may be located in the shared memory 930. In addition, the status variable and the count variable may be embedded in the structure variable.

The data sharing logic STD may store the switching PWM control value PWMCV in the new-data variable. In addition, before updating the new-data variable, the data sharing logic STD may increment the count variable embedded in the structure variable and may change the value of the status variable to a first status value.

In addition, after updating the new-data variable, the data sharing logic (STD) may change the value of the status variable to a second status value and may increment the count variable.

The second core 920 may include update logic UPD.

The update logic UPD may read the switching PWM control value (PWMCV) from the shared memory 930. In addition, the update logic UPD may update a register with the switching PWM control value (PWMCV).

The update logic UPD may store the switching PWM control value in a buffer-data variable, may store the value of the buffer-data variable in a previous-data variable, and may update the register with the value of the buffer-data variable or the previous-data variable according to the execution state of the data sharing logic STD.

The second core 920 may divide each switching PWM period into a first control period and a second control period and may execute the update logic UPD in each of the first control period and the second control period. The second core 920 may execute the update logic UPD in each of predetermined time intervals.

When the first core 910 executes the control calculation logic (CAL and STD) once in each switching PWM period, the update logic of the second core 920 may update the register with the value of the previous-data variable in the first control period and may update the register with the value of the buffer-data variable in the second control period.

The control calculation logic (CAL and STD) may change the status variable to the first status value, then may store the switching PWM control value in the new-data variable, and after the storage into the new-data variable is completed, may change the status variable to the second status value. In addition, when the status variable is the first status value, the update logic UPD may update the register with the value of the previous-data variable. After updating the register, the update logic UPD may wait until the status variable is changed to the second status value, and then may store the value of the new-data variable in the buffer-data variable.

The control calculation logic (CAL and STD) may change the status variable to the first status value, then may store the switching PWM control value in the new-data variable, and after the storage into the new-data variable is completed, may change the status variable to the second status value. In addition, when the status variable is the second status value, the update logic UPD may store the value of the new-data variable in the buffer-data variable and may update the register with the value of the buffer-data variable.

For the structure variable that includes the status variable and the count variable, the control calculation logic (CAL and STD) may increment the value of the count variable, may change the status variable to the first status value, then may store the switching PWM control value in the new-data variable, and after the storage into the new-data variable is completed, may change the status variable to the second status value and may increment the value of the count variable. In addition, the update logic UPD may store the structure variable in a temporary variable, and when the status variable of the temporary variable is the second status value and the value of the count variable of the temporary variable is different from the value of the count variable of the structure variable, may store the structure variable in the temporary variable again and then may check the execution state of the control calculation logic (CAL and STD).

In addition, when the status variable of the re-stored temporary variable is the first status value, the update logic UPD may update the register with the value of the previous-data variable. In addition, after updating the register, the update logic UPD may wait until the status variable of the temporary variable is changed to the second status value, while continuously storing the structure variable in the temporary variable, and then may store the value of the new-data variable in the buffer-data variable.

In addition, when the status variable of the re-stored temporary variable is the second status value, the update logic UPD may store the value of the new-data variable in the buffer-data variable and update the register with the value of the buffer-data variable.

The first core 910 may divide each switching PWM period into a first control period and a second control period. In each control period, the first core 910 may execute the calculation logic CAL that calculates a switching PWM control value by using an ADC sampling value for the inverter, and the first core 910 may execute the data sharing logic STD that stores the switching PWM control value in the new-data variable within the shared memory.

In addition, the second core 920 may execute the update logic UPD that updates the register in a predetermined update interval within each control period. When the update time point of the new-data variable is earlier than a set time point within the update interval, the update logic UPD updates the register with the value of the buffer-data variable storing the value of the new-data variable. When the update time point of the new-data variable is later than the set time point, the update logic UPD may update the register with the value of the previous-data variable storing the previous value of the buffer-data variable.

In addition, the PWM control circuit 940 may output a switching PWM signal that controls the inverter, by using values in the updated register.

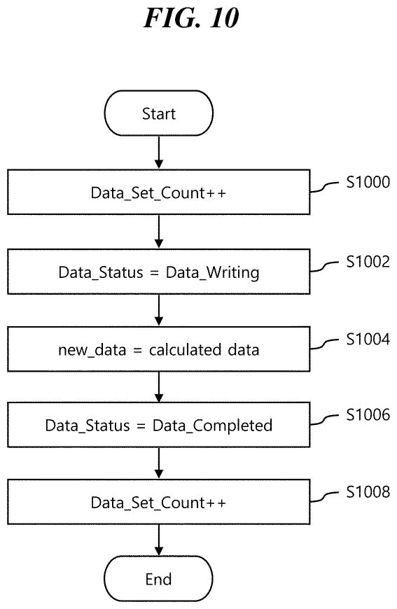

FIG. 10 is a flowchart of data sharing logic according to an embodiment.

Referring to FIG. 10, the data sharing logic may increment the value of a count variable Data_Set_Count (S1000).

In addition, the data sharing logic may set the value of a status variable Data_Status to a first status value (S1002). The first status value may be, for example, a value (e.g., 0) that signifies ‘Data_Writing’.

In addition, the data sharing logic may store the value calculated by calculation logic (calculated data), in a new-data variable new_data (S1004).

In addition, the data sharing logic may set the value of the status variable Data_Status to a second status value (S1006). The second status value may be, for example, a value (e.g., 1) that signifies ‘Data_Completed’.

In addition, the data sharing logic may increment the value of the count variable Data_Set_Count (S1008).

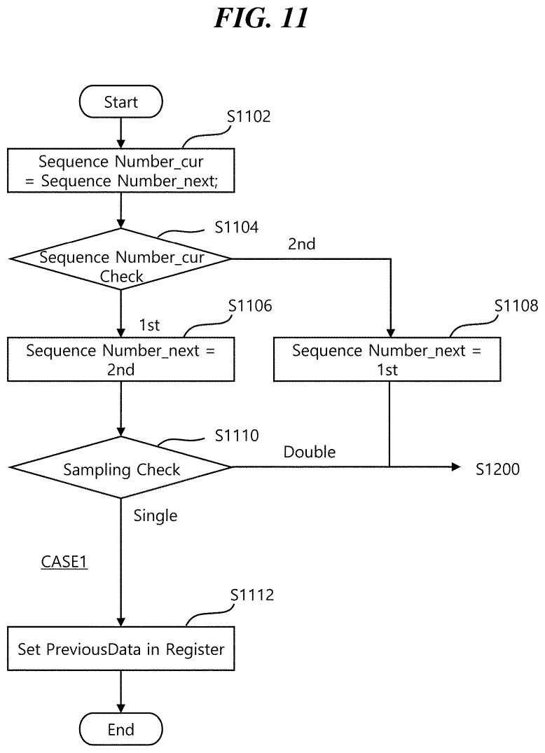

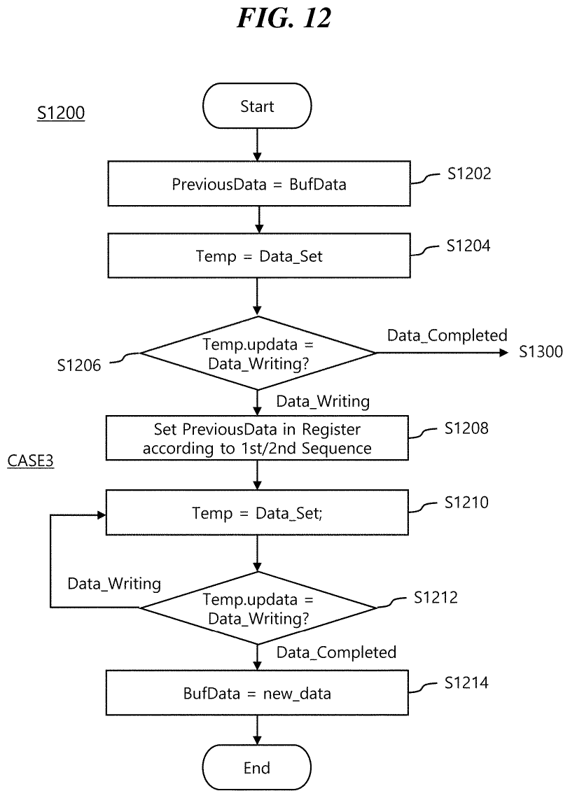

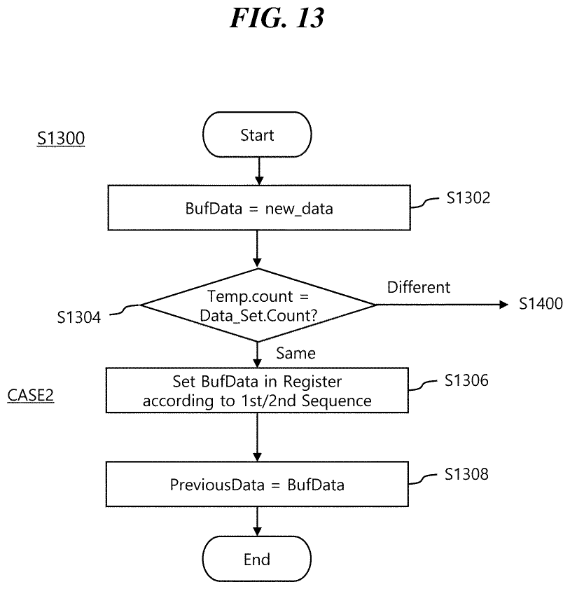

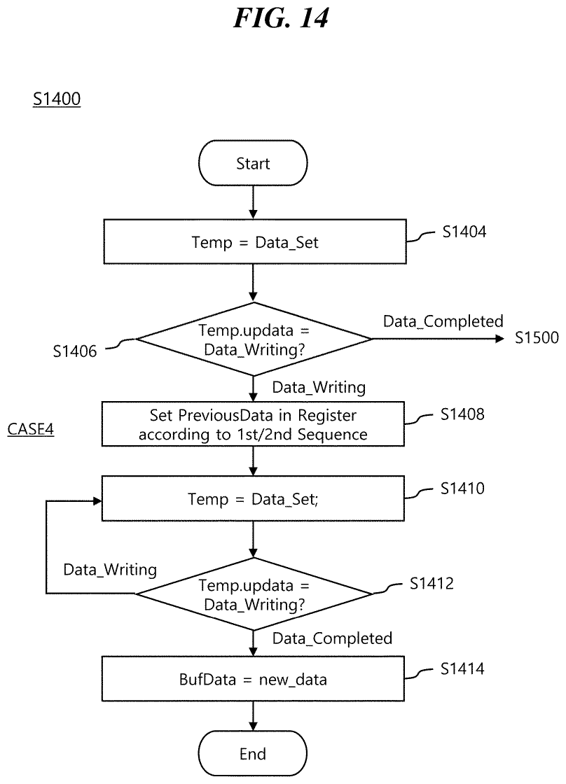

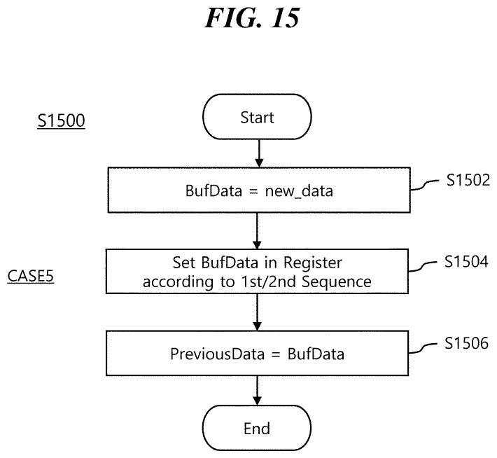

FIG. 11 is a flowchart of update logic for a first case, according to an embodiment, FIG. 12 is a flowchart of update logic for a second case, according to an embodiment, FIG. 13 is a flowchart of update logic for a third case, according to an embodiment, FIG. 14 is a flowchart of update logic for a fourth case, according to an embodiment, and FIG. 15 is a flowchart of update logic for a fifth case, according to an embodiment.

Referring to FIGS. 11-15, the update logic may copy a variable Sequence Number_next, which identifies the next control period, to a variable Sequence Number_cur that identifies the current control period (S1102).

In addition, the update logic may check the variable Sequence Number_cur that identifies the current control period (S1104).

In addition, when the variable Sequence Number_cur that identifies the current control period indicates a first control period (‘1st’ in S1104), the update logic may change the variable Sequence Number_next, which identifies the next control period, to indicate a second control period (S1106). In addition, when the variable Sequence Number_cur that identifies the current control period indicates the second control period (‘2nd’ in S1104), the update logic may change the variable Sequence Number_next, which identifies the next control period, to indicate the first control period (S1108).

In addition, when the current control period is the first control period, the update logic may check whether the number of samplings is set to 1 or 2 (S1110). In addition, when the number of samplings is set to 1 (‘Single’ in S1110), the update logic may update the register with the value of the previous-data variable, in the first control period (S1112).

This flow may correspond to an example of the first case CASE1 described above.

When the number of samplings is set to 2 (‘Double’ in S1110), or when the current control period is the second control period, the update logic may perform logic corresponding to the second case CASE2 to the fifth case CASE5 (S1200).

In S1200, the update logic may store the value of the buffer-data variable in the previous-data variable (S1202).

In addition, the update logic may store, in a temporary variable Temp, the value of a structure variable Data_Set located in a shared memory (S1204).

In addition, the update logic may check whether a status variable Temp.updata of the temporary variable is a first status value (S1206).

In addition, when the status variable Temp.updata of the temporary variable is the first status value (‘Data_Writing’ in S1206), the update logic may update the register with the value of the previous-data variable according to the sequence of the first control period and the second control period (S1208).

In addition, the update logic may, while continuously storing the structure variable in the temporary variable, wait until the status variable of the temporary variable is changed to a second status value (the ‘Data_Writing’ route in S1210 and S1212). Thereafter, the update logic may store the value of the new-data variable in the buffer-data variable (S1214).

This flow may correspond to an example of the third case CASE3 described above.

In S1206, when the status variable Temp.updata of the temporary variable is the second status value (‘Data_Completed’ in S1206), the update logic may perform logic corresponding to the second case CASE2, the fourth case CASE4, and the fifth case CASE5 (S1300).

In S1300, the update logic may store the value of the new-data variable in the buffer-data variable (S1302).

In addition, the update logic may compare the value of a count variable Temp.count of the temporary variable with the value of a count variable Data_Set.Count of the structure variable (S1304).

In addition, when the comparison indicates that the values are equal to each other (‘Same’ in S1304), the update logic may update the register with the value of the buffer-data variable according to the sequence of the first control period and the second control period (S1306) and may store the value of the buffer-data variable in the previous-data variable (S1308).

This flow may correspond to an example of the second case CASE2 described above.

When the comparison indicates that the values are different from each other (‘Different’ in S1304), the update logic may perform logic corresponding to the fourth case CASE4 and the fifth case CASE5 (S1400).

In S1400, the update logic may store, in the temporary variable Temp, the value of the structure variable Data_Set located in the shared memory (S1404).

In addition, the update logic may check whether the status variable Temp.updata of the temporary variable is the first status value (S1406).

In addition, when the status variable Temp.updata of the temporary variable is the first status value (‘Data_Writing’ in S1406), the update logic may update the register with the value of the previous-data variable according to the sequence of the first control period and the second control period (S1408).

In addition, the update logic may, while continuously storing the structure variable in the temporary variable, wait until the status variable of the temporary variable is changed to the second status value (the ‘Data_Writing’ route in S1410 and S1412). Thereafter, the update logic may store the value of the new-data variable in the buffer-data variable (S1414).

This flow may correspond to an example of the fourth case CASE4 described above.

In S1406, when the status variable Temp.updata of the temporary variable is the second status value (‘Data_Completed’ in S1406), the update logic may perform logic corresponding to the fifth case CASE5 (S1500).

In S1500, the update logic may store the value of the new-data variable in the buffer-data variable (S1502). In addition, the update logic may update the register with the value of the buffer-data variable according to the sequence of the first control period and the second control period (S1504) and may store the value of the buffer-data variable in the previous-data variable (S1506).

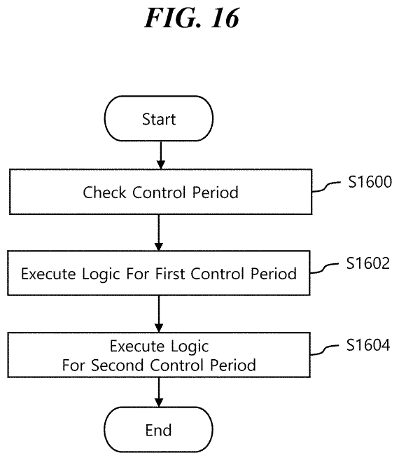

FIG. 16 is a flowchart of a data processing method of a second core according to an embodiment.

Referring to FIG. 16, the second core, which includes first storage logic that stores, in a buffer-data variable, a switching PWM control value calculated by a first core executing control calculation logic, and second storage logic that stores the value of the buffer-data variable in a previous-data variable, may process data according to the flow of FIG. 16.

The second core may divide each switching PWM period into a first control period and a second control period and may check whether the current control period is the first control period or the second control period (S1600).

In addition, in the first control period, the second core may check the number of ADC samplings of the first core in each switching PWM period. When the number of ADC samplings is 1, the second core may execute first update logic that updates a register with the value of the previous-data variable. When the number of ADC samplings is 2 or greater, the second core may execute second update logic that updates the register with the value of the buffer-data variable or the previous-data variable according to the execution state of the control calculation logic (S1602).

In addition, in the second control period, the second core may execute the second update logic (S1604).

For a structure variable that includes a status variable and a count variable, the control calculation logic may increment the value of the count variable, may change the status variable to a first status value, then may store a switching PWM control value in a new-data variable, and after the storage into the new-data variable is completed, may change the status variable to a second status value and increment the value of the count variable. In addition, the first storage logic may store the value of the new-data variable in the buffer-data variable.

The second update logic may specifically include executing the second storage logic, storing the value of the structure variable in a temporary variable, checking whether a status variable of the temporary variable is the first status value, and, when the status variable of the temporary variable is the first status value, updating the register with the value of the previous-data variable.

In addition, the second update logic may further include, after the updating of the register with the value of the previous-data variable, waiting until the status variable of the temporary variable is changed to the second status value while continuously storing the structure variable in the temporary variable, and then executing the first storage logic.

In addition, the second update logic may further include, when the status variable of the temporary variable is the second status value, executing the first storage logic, comparing the value of a count variable of the temporary variable with the value of the count variable of the structure variable, and, when the value of the count variable of the temporary variable and the value of the count variable of the structure variable are equal to each other, updating the register with the value of the buffer-data variable and executing the second storage logic.

In addition, the second update logic may further include, when the value of the count variable of the temporary variable and the value of the count variable of the structure variable are different from each other, storing the structure variable in the temporary variable again, checking whether the status variable of the re-stored temporary variable is the first status value, and, when the status variable of the re-stored temporary variable is the first status value, updating the register with the value of the previous-data variable.

As described above, according to an embodiment of the present disclosure, an inverter may maintain data coherency in any case. Furthermore, according to an embodiment of the present disclosure, data coherency may be ensured in an inverter in which double sampling is performed.

The terms such as “include,” “comprise,” or “have” described above mean that the corresponding component may be inherent as long as there is no particular opposing recitation, and thus, it should be interpreted that other components may be further included rather than excluded. All terms used herein, including technical and scientific terms, have the same meaning as commonly understood by those of ordinary skill in the art, unless defined otherwise. Terms, such as those defined in commonly used dictionaries should be interpreted as having a meaning that is consistent with their meaning in the context of the relevant art and the present disclosure and should not be interpreted in an idealized or overly formal sense unless expressly so defined herein.

The above description merely explains the technical idea of the present disclosure and the present disclosure may be changed and modified in various ways without departing from the scope of the present disclosure by those of ordinary skill in the art. Accordingly, the embodiments described herein are provided not to limit, but to merely explain the technical idea of the present disclosure, and the technical idea of the present disclosure is not limited by the embodiments. The scope of the present disclosure should be construed by the following claims, and all technical ideas within the equivalent scope should be construed as being included in the scope of the present disclosure.

What is claimed is:

1. An inverter control device comprising:
a first core configured to execute control calculation logic to calculate a switching pulse-width modulation (PWM) control value by using an analog-to-digital converter (ADC) sampling value for an inverter;
a second core configured to execute update logic to:
store the switching PWM control value in a buffer-data variable;
store a value of the buffer-data variable in a previous-data variable; and
update a register with the value of the buffer-data variable or the previous-data variable according to an execution state of the control calculation logic; and
a PWM control circuit configured to output a switching PWM signal to control the inverter, by using a value within the register.

2. The inverter control device of claim 1, wherein the second core is further configured to:
divide each switching PWM period into a first control period and a second control period; and
execute the update logic in each of the first control period and the second control period.

3. The inverter control device of claim 2, wherein when the first core executes the control calculation logic once in each switching PWM period, the second core is configured to execute the update logic to:
update, in the first control period, the register with the value of the previous-data variable; and
update, in the second control period, the register with the value of the buffer-data variable.

4. The inverter control device of claim 1, wherein the first core is configured to execute the control calculation logic to:
change a status variable to a first status value;
store the switching PWM control value in a new-data variable; and
after the storing in the new-data variable is completed, change the status variable to a second status value, and
wherein when the status variable is the first status value, the second core is configured to execute the update logic to update the register with the value of the previous-data variable.

5. The inverter control device of claim 4, wherein the second core is configured to execute the update logic to, after updating the register:
wait until the status variable is changed to the second status value; and
store a value of the new-data variable in the buffer-data variable.

6. The inverter control device of claim 1, wherein the first core is configured to execute the control calculation logic to:
change a status variable to a first status value;
store the switching PWM control value in a new-data variable; and
after the storing in the new-data variable is completed, change the status variable to a second status value, and
wherein when the status variable is the second status value, the second core is configured to execute the update logic to:
store a value of the new-data variable in the buffer-data variable; and
update the register with the value of the buffer-data variable.

7. The inverter control device of claim 1, wherein, when a structure variable comprises a status variable and a count variable, the first core is configured to execute the control calculation logic to:
increment a value of the count variable;
change the status variable to a first status value;
store the switching PWM control value in a new-data variable; and
after the storing in the new-data variable is completed, change the status variable to a second status value and increment a value of the count variable, and
wherein when the structure variable comprises the status variable and the count variable, the second core is configured to execute the update logic to:
store the structure variable in a temporary variable; and
when a status variable of the temporary variable is the second status value and a value of a count variable of the temporary variable is different from the value of the count variable of the structure variable, re-store the structure variable in the temporary variable and determine the execution state of the control calculation logic.

8. The inverter control device of claim 7, wherein when the status variable of the re-stored temporary variable is the first status value, the second core is configured to execute the update logic to update the register with the value of the previous-data variable.

9. The inverter control device of claim 8, wherein the second core is configured to execute the update logic to, after updating the register:
wait until the status variable of the temporary variable is changed to the second status value while continuously storing the structure variable in the temporary variable; and
store the value of the new-data variable in the buffer-data variable.

10. The inverter control device of claim 7, wherein, when the status variable of the re-stored temporary variable is the second status value, the second core is configured to execute the update logic to:
store the value of the new-data variable in the buffer-data variable; and
update the register with the value of the buffer-data variable.

11. The inverter control device of claim 1, wherein the second core is further configured to:
divide each switching PWM period into a first control period and a second control period; and
execute the update logic in a predetermined time interval within each of the first control period and the second control period.

12. A data processing method of a core, the data processing method comprising:
dividing each switching pulse-width modulation (PWM) period into a first control period and a second control period;
determining whether a current control period is the first control period or the second control period;
in the first control period, determining a number of analog-to-digital converter (ADC) samplings of another core in each switching PWM period;
when the number of ADC samplings is 1, executing first update logic to update a register with a value of a previous-data variable;
when the number of ADC samplings is 2 or greater, executing second update logic to update the register with a value of a buffer-data variable or the value of the previous-data variable according to an execution state of control calculation logic executed by the another core; and
executing the second update logic in the second control period.

13. The data processing method of claim 12, wherein when a structure variable that comprises a status variable and a count variable, the method further comprises:
executing a first storage logic to store, in the buffer-data variable, a value of a new-data variable.

14. The data processing method of claim 13, wherein executing the second update logic comprises:
executing a second storage logic;
storing a value of the structure variable in a temporary variable;
determining whether a status variable of the temporary variable is a first status value; and
when the status variable of the temporary variable is the first status value, updating the register with the value of the previous-data variable.

15. The data processing method of claim 14, wherein executing the second update logic further comprises:
after the updating of the register with the value of the previous-data variable, waiting until the status variable of the temporary variable is changed to the second status value while continuously storing the structure variable in the temporary variable; and
after the updating of the register with the value of the previous-data variable, executing the first storage logic to store, in the buffer-data variable, the value of the new-data variable.

16. The data processing method of claim 14, wherein executing the second update logic further comprises, when the status variable of the temporary variable is the second status value:
executing the first storage logic to:
store, in the buffer-data variable, the value of the new-data variable; and
update the register with the value of the buffer-data variable;
comparing a value of a count variable of the temporary variable with a value of the count variable of the structure variable; and
when the value of the count variable of the temporary variable is equal to the value of the count variable of the structure variable, updating the register with the value of the buffer-data variable and executing the second storage logic to store, in the previous-data variable, the value of the buffer-data variable.

17. The data processing method of claim 16, wherein executing the second update logic further comprises, when the value of the count variable of the temporary variable is different from the value of the count variable of the structure variable:
re-storing the structure variable in the temporary variable;
determining whether the status variable of the re-stored temporary variable is the first status value; and
when the status variable of the re-stored temporary variable is the first status value, updating the register with the value of the previous-data variable.

18. The data processing method of claim 12, wherein the first update logic or the second update logic is executed in a predetermined time interval within the first control period.

19. An inverter control device comprising:
a first core configured to:
divide each switching pulse-width modulation (PWM) period into a first control period and a second control period;
in each control period, execute calculation logic to calculate a switching PWM control value by using an analog-to-digital converter (ADC) sampling value for an inverter and execute data sharing logic to store, in a new-data variable within a shared memory, the switching PWM control value;
a second core configured to:
execute update logic to update a register in a predetermined update interval within each control period;
when an update time point of the new-data variable is earlier than a set time point within the predetermined update interval, execute the update logic to update the register with a value of a buffer-data variable storing a value of the new-data variable; and
when the update time point of the new-data variable is later than the set time point, execute the update logic to update the register with a value of a previous-data variable storing a previous value of the buffer-data variable; and
a PWM control circuit configured to output a switching PWM signal to control the inverter, by using a value within the register.

20. The inverter control device of claim 19, wherein the second core is further configured to, after updating the register with the value of the previous-data variable, store, in the buffer-data variable, the value of the new-data variable.
